(19) United States
(12) Patent Application Publication
(10) Pub. No.: US 2014/0116629 A1
(43) Pub. Date: May 1, 2014

(54) SINGLE POINT INFLATION SYSTEM FOR TIRE CHANGER

(71) Applicant: Hennessy Industries, Inc., LaVergne, TN (US)

(72) Inventor: John Story, Murfreesboro, TN (US)

(21) Appl. No.: 14/066,078

(22) Filed: Oct. 29, 2013

Related U.S. Application Data
(60) Provisional application No. 61/719,854, filed on Oct. 29, 2012.

(51) Int. Cl. B60C 25/12; B60C 25/05

(52) U.S. Cl. CPC B60C 25/12; B60C 25/05
USPC 157/1.24; 157/1.1

(57) ABSTRACT

A wheel servicing machine includes an inflation apparatus for sealing or seating a tire bead on a wheel rim. The inflation apparatus includes a nozzle with an orifice operable to emit a jet of compressed gas toward the interface of the tire bead and wheel rim when the wheel rim is mounted on a wheel holder. The nozzle is positioned such that the jet of compressed gas may interchangeably engage the tire and wheel rim interfaces on different-sized wheel and tire combinations when placed on the wheel holder, without repositioning the nozzle. The nozzle may be used with two or more different-sized wheel rim and tire combinations without changing the nozzle location. The wheel servicing machine may also include a tire changing machine, and the nozzle may be fixed to a base on the tire changing machine.

### CROSS-REFERENCES TO RELATED APPLICATIONS

This application claims benefit of and priority to provisional U.S. Patent Application Ser. No. 61/719,854, entitled Single Point Inflation System for Tire Changer filed Oct. 29, 2012, all of which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

The present invention relates generally to devices and methods for inflating a tire, seating a tire bead relative to a wheel rim, or sealing a tire bead relative to a wheel rim mounted on a wheel servicing machine. More particularly, the present invention relates to a wheel servicing machine such as a tire changing machine having a rotatable wheel holder and an inflation nozzle positioned on the machine near the wheel holder.

Conventional wheel servicing machines such as tire changing machines and/or wheel balancers typically include a base and a wheel holder extending from the base for mounting a wheel rim thereon. The wheel rim may be clamped or otherwise attached to the wheel holder to secure the wheel rim in place during a tire servicing operation. For example, conventional tire changing machines typically include a wheel holder extending upwardly from a base for clamping a wheel rim while a tire is installed onto or removed from the wheel rim. After a tire is installed onto the rim while the rim is secured by the wheel holder, the tire bead must be seated in a proper location on the wheel rim. Typically, a radial tire has an inner semi-rigid bead that must be sealed against the rim and then forced into a corresponding groove, or bead seat, on the outer perimeter of the wheel rim. The process of forcing the tire bead into the bead seat may be referred as bead-seating. Bead-seating operations are typically performed by forcing a stream of compressed air directly into the tire at a position along the intersection of the wheel rim and the tire bead. The compressed air is forced into the tire in a quick burst, causing the tire sidewalls to rapidly move outwardly—thereby pressing the tire bead against the rim and forcing, or seating, the tire bead into a corresponding bead location or groove on the wheel rim. Bead-seating sometimes does not utilize the tire inflation valve.

Using conventional machines and methods, the tire and wheel rim assembly may be removed from the machine after tire installation for bead-seating and inflation. The tire/rim assembly may then be inflated with pressurized air from separate inflation equipment to initially seat the tire bead on the wheel rim and subsequently to inflate the tire. However, the procedure of installing the tire and then removing the wheel tire/rim assembly for remote bead-seating and inflation is time-consuming as it requires additional operator steps off the machine. This reduces worker efficiency, contributes to worker fatigue, and reduces machine throughput.

Others have attempted to overcome these problems by providing a portable, external pressurized air source such as an air blast tank or compressed air supply line that can be manually positioned near the tire/rim interface. A controlled blast of air may be directed toward the tire/rim interface while the tire/rim assembly is still mounted on the wheel holder. This may be used to seat the tire bead. However, such external inflation devices may be burdensome to manipulate and can be dangerous as the jet of air produced can damage a user's hands or cause bodily injury if placed in the air stream. Additionally, manually operable supply lines must be tethered to a compressed air source and can get tangled in other mechanical components on the machine during use. Detachable inflation tanks on the other hand are not tethered, but must be refilled with compressed air after repeated use.

Still others have sought to solve the problem of bead-seating by providing one or more air jet orifices on the wheel holder itself. Such orifices may be placed on rim clamps, rim clamp carriers, or wheel holder tabletop structures. In such conventional devices where the jet orifice is on the wheel holder itself, one or more couplings are necessary to maintain fluid connection to a compressed air source during wheel holder rotation. Such couplings can become jammed or inadvertently disconnected and are generally expensive. Additionally, these conventional solutions often require multiple jets and are generally unique to a specific wheel holder. As such, conventional wheel holder inflation devices may not be interoperable with wheel rims having different diameters. Additionally, these devices make wheel rim clamp and clamp carrier adjustment and replacement difficult and time-consuming. These devices also limit the amount and volume of air flow that can be achieved in a short period of time for bead sealing and seating.

What is needed, then, are improvements in inflation devices for providing an air blast toward a wheel rim and tire bead interface for sealing a tire bead against the wheel rim and/or seating a tire bead in a corresponding bead seat on the wheel rim. Also needed are associated methods of tire bead sealing and tire bead seating.

### BRIEF SUMMARY

The present invention generally provides a wheel servicing machine having an improved apparatus for sealing and/or seating a tire bead on a wheel rim using a jet of compressed gas.

A wheel servicing machine includes a base and a rotatable wheel holder extending from the base. The wheel holder is configured to rotate about a wheel holder axis of rotation. A nozzle is positioned on the base. The nozzle includes an orifice oriented toward the wheel holder axis of rotation. The nozzle is positioned such that a jet of compressed gas emitted from the nozzle may assist in seating or sealing a tire bead on a wheel rim.

Another aspect of the present invention is a single-point inflation device for a tire changing machine. The device includes a nozzle positioned at a fixed location relative to a wheel holder. The nozzle is configured to produce a jet of compressed gas toward the wheel holder to assist with tire bead seating and/or tire bead sealing against the wheel rim. The jet of compressed gas may engage the tire and wheel rim interface on different sized wheel and tire combinations. For example, a single nozzle fixed to the base may be used to seat or seal numerous tire wheel combinations having different dimensions without moving the nozzle.

Another object of the present invention is to provide a tire changing machine having a single-point inflation system and a wheel holder that does not interfere with the jet of compressed gas emitted from the nozzle.

A further object of the present invention is to provide a method of sealing or seating a tire bead on a wheel rim.

An additional object of the present invention is to provide an inflation apparatus for a wheel servicing machine, such as a tire changing machine, that can be used to seal and/or seat tire beads on wheels of various sizes without moving the inflation apparatus relative to the wheel holder.

A further object of the present invention is to provide a nozzle with an orifice vertically offset above the wheel holder such that the emitted jet of compressed air does not contact the wheel holder.

Yet another object of the present invention is to provide a nozzle that is horizontally offset, or radially offset, away from the wheel holder.

Numerous other objects, advantages and features of the present invention will be readily apparent to those of skill in the art upon a review of the following drawings and description of a preferred embodiment of the invention.

### BRIEF DESCRIPTION OF DRAWINGS

FIG. 1 illustrates a schematic elevation view of an embodiment of a wheel servicing machine in accordance with the present invention.

FIG. 2 illustrates a detailed schematic view of an embodiment of a nozzle and wheel holder on a wheel servicing machine.

FIG. 3 illustrates a perspective view of an embodiment of a wheel servicing machine in accordance with the present invention.

FIG. 4 illustrates a detail perspective view of an embodiment of a nozzle and wheel holder on a wheel servicing machine.

### DETAILED DESCRIPTION

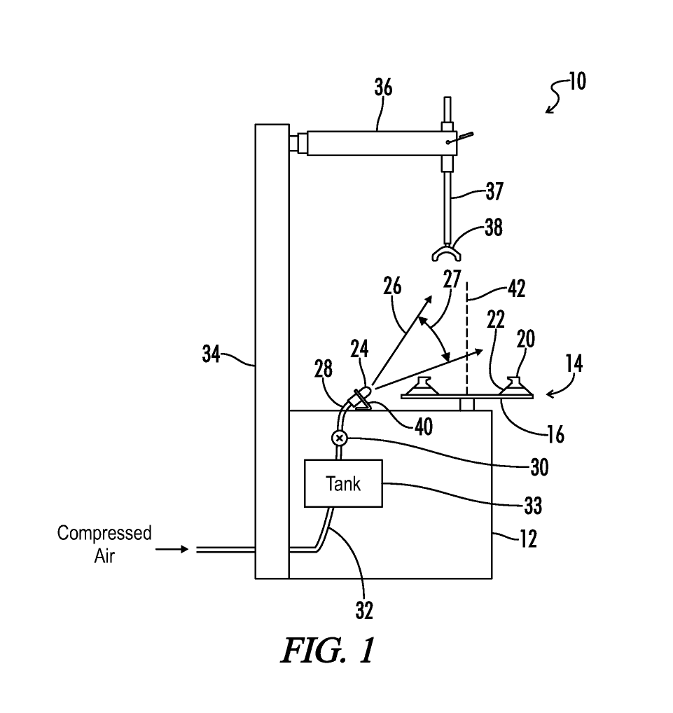

Referring now to the drawings, FIG. 1 illustrates an embodiment of wheel servicing machine 10 such as a swing-arm tire changer. Wheel servicing machine 10 includes a base 12 and a rotatable wheel holder 14 extending from base 12. Wheel holder 14 includes a tabletop style rim clamp wheel holder in some embodiments, but may include any other suitable type of wheel holder for securing a wheel rim. Wheel holder 14 in some embodiments includes a tabletop 16 or platform upon which a wheel rim may be mounted. One or more clamps 20 are mounted on corresponding clamp carriers 22 on tabletop 16 in some embodiments. Each clamp 20 engages a wheel rim.

A nozzle 24 is situated near wheel holder 14. Nozzle 24 is generally configured to provide one or more blasts of air toward wheel holder 14 for sealing and seating a tire in position on a wheel rim secured by wheel holder 14. Nozzle 24 is positioned to emit a blast of air generally toward the intersection between the tire bead and the wheel rim. Nozzle 24 includes an orifice 48, or opening, from which a pressurized air jet 26 is emitted. Jet 26 may be emitted in the shape of a cone as seen in FIGS. 1, 3 and 4 in some embodiments. The jet 26 has a cone angle 27, seen in FIG. 1 that defines the general shape of the air blast. The cone shape of the air blast is axisymmetric in some embodiments.

Referring further to FIG. 1, in some embodiments, the nozzle 24 is positioned near wheel holder 14 on base 12. Nozzle 24 may be installed on a nozzle mount 40 such as a mounting plate or mounting flange. Nozzle mount 40 may be secured directly or indirectly to base 12. The location of nozzle mount 40 determines the location from which the jet of compressed air is directed toward the wheel holder 14.

Also seen in FIG. 1, tank 33 is disposed on base 12 in some embodiments. Tank 33 includes a reservoir for storing compressed gas such as compressed air. Tank 33 may include a compressed air tank housed within base 12 in some embodiments. In alternative embodiments, tank 33 is positioned on the exterior of base 12 or located remote from base 12. Tank 33 may include a cylindrical storage tank in some embodiments.

Tank 33 is coupled to, or maintained in fluid communication with, nozzle 24 via a nozzle supply hose 28. Nozzle supply hose 28 includes any suitable tube or hose for delivering gas from tank 33 to nozzle 24. A valve 30 may be disposed along nozzle supply hose 28 between tank 33 and nozzle 24. Valve 30 includes a solenoid valve in some embodiments. Valve 30 may be selectively opened or closed to control the flow of compressed gas from tank 33 to nozzle 24. Valve 30 in some embodiments is located on nozzle 24. In alternative embodiments, valve 30 is located on tank 33. Valve 30 may also be housed within base 12 in some embodiments.

A tank supply line 32 may also be coupled to tank 33 for providing gas to tank 33. The volume of tank 33 is generally chosen such that a quick blast of compressed air can be emitted from nozzle 24 when valve 30 is opened. Once tank 33 is partially or fully evacuated following an air blast, tank supply line 32 provides gas to refill tank 33. Tank supply line 32 may be coupled to a compressor or other source of compressed gas to refill and/or maintain pressure in tank 33. An additional tank supply valve may be disposed on tank supply line 32 in some embodiments. A compressor is attached to tank 33 on base 12 in some embodiments.

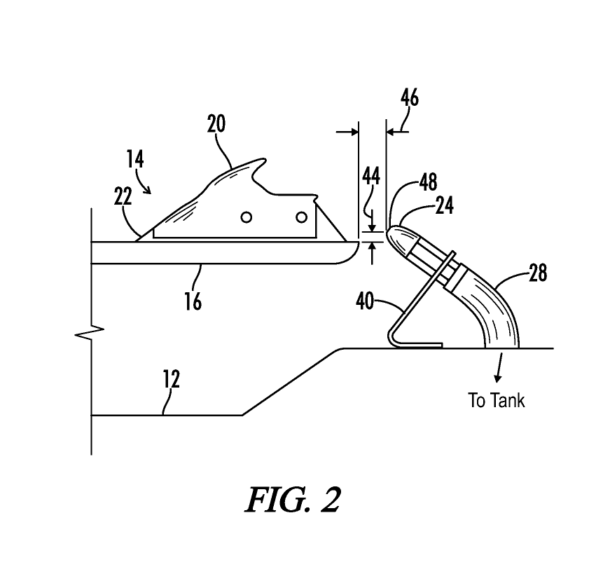

Referring further to FIG. 2, in some embodiments, orifice 48 on nozzle 24 is generally oriented toward wheel holder 14. Orifice 48 is defined as one or more holes or openings in nozzle 42 from which compressed gas is emitted. Orifice 48 in some embodiments is vertically offset above tabletop 16, as seen in FIG. 2, by a vertical offset distance 44. As such, a conical stream of compressed gas emitted from orifice 48 does not interfere with or directly contact tabletop 16. Rather, the conical stream of compressed gas flows from orifice 48 toward the axis of rotation of wheel holder 14 at an upward angle without passing between or through the support arms 17a, 17b, 17c, 17d on the tabletop 16 in some embodiments. As such, the device is configured such that the jet 26 does not interfere with tabletop 16 during inflation.

In further embodiments, the vertical offset distance 44 is zero and the orifice is substantially aligned with the upper surface of platform 16.

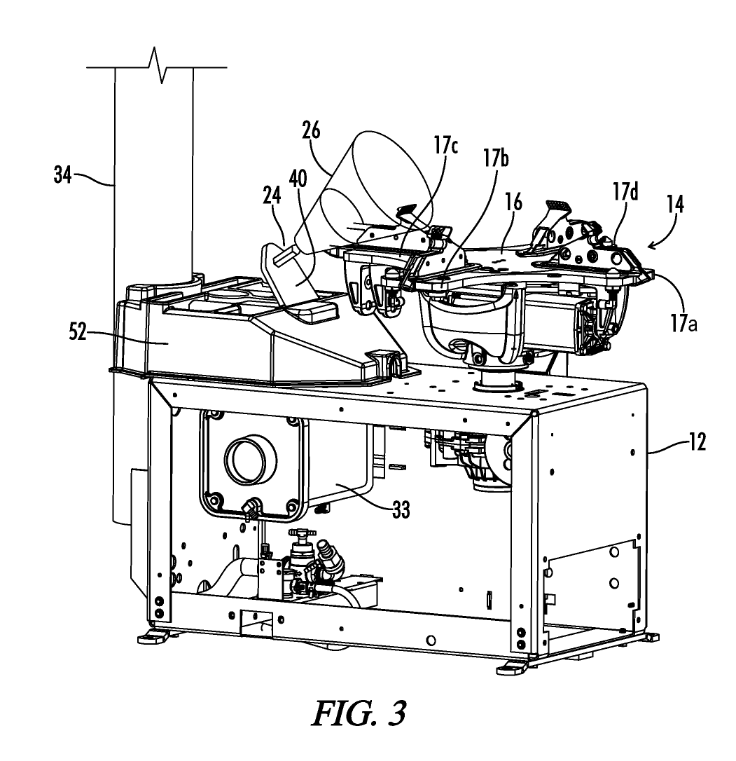

Additionally, as seen in FIG. 3, in some embodiments, orifice 48 may also horizontally offset away from platform 16 in the radial direction relative to wheel holder axis of rotation by a horizontal offset distance 46. Horizontal offset distance 46 provides a radial gap between wheel holder 14 and orifice 48. This radial gap further provides clearance between the conical jet 26 of compressed gas emitted from orifice 48 and wheel holder 14 in some embodiments.

Referring again to FIG. 1, in some embodiments, wheel servicing machine 10 includes a tire changer including a base 12, a support column 34 extending upwardly from the base, and a swing arm 36 pivotally attached to the support column 34. A vertically moveable tire changing tool head 38 is disposed on a moveable shaft 37 disposed on the distal end of the swing arm 36. Tool head 38 may be selectively raised or lowered relative to wheel holder 14 for performing wheel servicing operations.

As seen in FIG. 3, in some embodiments, an accessory tray 52 is installed on base 12 between wheel holder 14 and support tower 34. Accessory tray 52 includes a plurality of recessions or cavities for storing accessories such as wheel weights or tools in some embodiments. In some applications, nozzle mount 40 is installed on accessory tray 52, as seen in FIG. 3, such that nozzle 24 is elevated above the base 12. In alternative embodiments, nozzle mount 40 is installed directly on base 12.

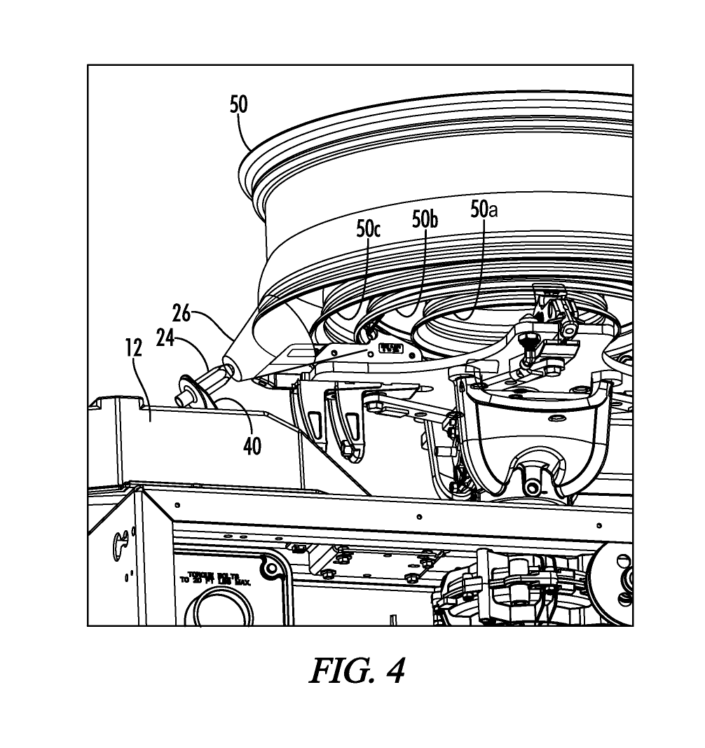

Referring further to FIG. 4, in some embodiments, nozzle 24 is configured and positioned such that the conical jet of compressed air 26 is shaped to provide inflation for numerous wheel rim sizes. For example, the outer perimeter of a smaller wheel rim 50a is contacted by an outer portion of the conical jet of compressed air 26. Without repositioning the nozzle 24, the outer perimeter of larger wheel rims 50b, 50c may also be contacted by the same conical jet. As such, the present invention provides a single point inflation system in some embodiments that is interoperable with various wheel rim sizes without modifying nozzle 24 or adjusting the nozzle location. In other embodiments, nozzle 24 is moveable relative to base to further accommodate a larger range of wheel diameters.

In additional embodiments, the present invention provides a method of sealing a tire bead against a wheel rim. The method includes the steps of (a) providing a nozzle fixed on a base of a tire changing machine oriented toward a rotatable wheel holder; (b) positioning a tire on a wheel rim secured by the wheel holder; (c) emitting a conical jet of compressed gas from the nozzle toward the intersection between the tire and the wheel rim. In some embodiments the conical jet of compressed gas includes compressed air. In other embodiments, the conical jet of compressed gas includes nitrogen or another suitable inert gas. The method further includes the step of sealing the tire against the wheel rim. In additional embodiments, the method further includes the step of also seating the tire bead relative to the wheel rim. In some embodiments, the method includes sealing and seating the tire relative to the wheel rim using only the conical jet of compressed gas from the nozzle.

Thus, although there have been described particular embodiments of the present invention of a new and useful Single Point Inflation System for Tire Changer it is not intended that such references be construed as limitations upon the scope of this invention except as set forth in the following claim.

What is claimed is:

1. A wheel servicing apparatus, comprising:
a base;
a rotatable wheel holder extending from the base; and
a nozzle attached to the base, the nozzle including an orifice oriented toward the wheel holder.

2. The apparatus of claim 1, wherein the nozzle is operable to emit a jet of pressurized gas toward the wheel holder.

3. The apparatus of claim 2, wherein the jet is conical.

4. The apparatus of claim 2, wherein the nozzle is positioned at a fixed location relative to the rotatable wheel holder.

5. The apparatus of claim 2, wherein the nozzle is fixed relative to the base.

6. The apparatus of claim 1, further comprising a nozzle mount located on the base, wherein the nozzle is positioned on the nozzle mount.

7. The apparatus of claim 1, wherein the orifice is radially spaced from the rotatable wheel holder by a horizontal offset distance

8. The apparatus of claim 7, wherein the orifice is vertically spaced from the rotatable wheel holder by a vertical offset distance.

9. The apparatus of claim 8, wherein the nozzle is configured to emit a jet oriented at an angle relative to the axis of rotation of the rotatable wheel holder.

10. The apparatus of claim 9, wherein the angle is acute.

11. The apparatus of claim 1, further comprising:
a pressure tank coupled to the nozzle; and
a valve positioned between the pressure tank and the nozzle.

12. The apparatus of claim 11, wherein the pressure tank is disposed on the base.

13. The apparatus of claim 11, further comprising a nozzle supply hose extending between the pressure tank and the nozzle.

14. The apparatus of claim 11, further comprising a tank supply line coupled to the tank, the tank supply line configured for attachment to an external compressed gas source.

15. The apparatus of claim 12, further comprising a compressor coupled to the pressure tank.

16. A method of sealing a tire bead against a wheel rim, comprising: the steps of:
(a) providing a nozzle at a fixed location on a base of a tire changing machine, the nozzle oriented toward a rotatable wheel holder on the base;
(b) positioning a first tire on a first wheel rim having a first diameter, the first wheel rim secured by the wheel holder;
(c) emitting a first jet of compressed gas from the nozzle toward the first tire and first wheel rim interface; and
(d) seating a tire bead on the first tire relative to the first wheel rim.

17. The method of claim 16, further comprising:
removing the first wheel rim and first tire from the wheel holder;
positioning a second tire and a second wheel rim on the wheel holder;
emitting a second jet of compressed gas from the nozzle toward the second tire and second wheel rim interface without repositioning the nozzle; and
seating a tire bead on the second tire relative to the second wheel rim.

18. The method of claim 17, wherein the nozzle is positioned such that the wheel holder does not interfere with the first jet of compressed gas.

19. The method of claim 18, wherein the nozzle is positioned such that the wheel holder does not interfere with the second jet of compressed gas.

20. The method of claim 19, wherein the nozzle includes an orifice vertically and horizontally offset from the wheel holder.
